(19) United States
(12) Patent Application Publication
(10) Pub. No.: US 2007/0051590 A1
(43) Pub. Date: Mar. 8, 2007

(54) Keypad device

(76) Inventor: Chin-Te Chiu, Tu-Cheng City (TW)

Correspondence Address: LIN & ASSOCIATES INTELLECTUAL PROPERTY, P.O. BOX 2339, SARATOGA, CA, 95070-0339, US

(21) Appl. No.: 11/220,774

(22) Filed: Sep. 6, 2005

(51) Int. Cl. H01H 13/72

(52) U.S. Cl. 200/5 A

(57) ABSTRACT

A keypad device includes a key-mat and a switch assembly. The key-mat has a plurality of spaced key portions. The switch assembly includes a plurality of switches disposed under the respective key portions. A plurality of slots is defined in the key-mat. Each slot is disposed between a pair of the adjacent key portions such that the linkage between the adjacent key portions is destroyed. Thus a pressure on a given key portion is not transferred to its adjacent key portions, thereby unwanted key presses are avoided.

### BACKGROUND OF THE INVENTION

1. Field of the Invention

The present invention relates to a keypad device, and more particularly to a keypad device in which unwanted key presses are avoided.

2. The Related Art

Keypads are used in the user interfaces of devices such as calculators and radiotelephones (e.g. mobile phones). One design of a conventional keypad device is shown in cross-section in FIG. 4. There is a key-mat 120 which has key portions 122 joined to the main web of the key-mat 120. Each key portion 122 has an upper region 124 which projects through a corresponding hole 162 in an outer housing 160 of the device, and a lower region 126 which terminates in a projection 128. When a user presses the upper region 124 of the key portion 122, the key portion 122 travels towards a switch assembly 140 associated with the key portion 122 so that the projection 128 can engage the switch as illustrated in FIG. 4. When the key portion 122 is released, it returns to its original position. The switch assembly 140 comprises an upper assembly 141, including a flexible dome 143 made of metal sheet material, and a lower assembly 145 including a circuit board 147 with exposed conductive tracks 149. When the key portion 122 is pressed, it urges the dome 143 to deform suddenly to the configuration illustrated in FIG. 4, in which it bridges the conductive tracks 149 of the switch assembly 140 and connects them together electrically. This connection is sensed by the device. When the key portion 122 is released, the dome 143 returns to its natural state, disconnecting the tracks 149 from each other.

Such keypad devices are widely used, but they suffer from a serious problem as illustrated in FIG. 4 and hereinafter. As the adjacent key portions 122 are connected with each other directly with no obstructions on the key-mat 120, linkage exits between the adjacent key portions 122. This results in a tendency for pressure on a given key portion to drag down its neighbour, which can result in unwanted key presses. This in turn may lead to incorrectly dialled telephone numbers, for instance.

In view of the above, an improved keypad device that overcomes the above-mentioned problem is strongly desired.

### SUMMARY OF THE INVENTION

According to a first aspect of the present invention, there is provided a keypad device including a key-mat and a switch assembly. The key-mat has a plurality of spaced key portions. The switch assembly includes a plurality of switches disposed under the respective key portions. At least one slot is defined in the key-mat between a pair of the adjacent key portions.

Advantageously, the slot between the pair of the adjacent key portions can destroy the linkage there-between. Thus a pressure on a given key portion is not transferred to its adjacent key portions. This results in there being less likelihood of dragging down the adjacent key portions, thereby unwanted key presses on the adjacent key portions are avoided.

According to a second aspect of the present invention, there is provided a key-mat for use in a keypad device that includes a switch assembly having a plurality of switches. The key-mat has a plurality of spaced key portions overlying the respective switches. At least one slot is defined in the key-mat between a pair of the adjacent key portions such that the linkage between the adjacent key portions is destroyed.

Other objects, advantages and novel features of the invention will become more apparent from the following detailed description of a preferred embodiment thereof when taken in conjunction with the accompanying drawing, wherein:

### BRIEF DESCRIPTION OF THE DRAWINGS

FIG. 1 is a cross-sectional view of a keypad device in accordance with the present invention;

FIG. 2 is a perspective view of a key-mat for the keypad device shown in FIG. 1;

FIG. 3 is a cross-sectional view of the keypad device with an illustrated key portion thereof pressed down; and

FIG. 4 is a cross-sectional view of a conventional keypad device.

### DETAILED DESCRIPTION OF THE PREFERRED EMBODIMENT

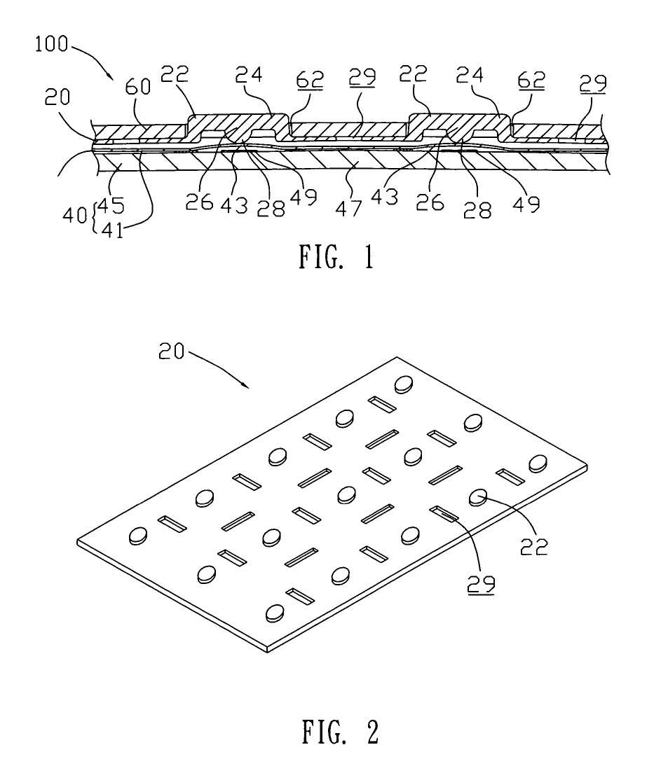

Referring to the drawings in detail, and first to FIG. 1, a keypad device 100 according to the present invention is illustrated, which is used in a electronic device, such as a mobile phone or the like. The keypad device 100 includes a key-mat 20 and a switch assembly 40 engaged with the key-mat 20.

Referring to FIG. 2 in conjunction with FIG. 1, the key-mat 20 has a plurality of spaced key portions 22, which are arranged in matrix array and each is joined to the main web of the key-mat 20. Each key portion 22 has an upper region 24 which projects through a corresponding hole 62 in an outer housing 60 of the electronic device for being accessed by fingers of a user, and a lower portion 26 which projects downwards to form a protuberance 28 for controlling a switch of the switch assembly 40. The key-mat 20 further has a plurality of slots 29 defined therein. Each slot 29 is disposed between a pair of adjacent key portions 22 for destroying the linkage between the adjacent key portions 22.

With reference to FIG. 1 again, the switch assembly 40 disposed under the key-mat 20 includes an upper assembly 41 and a lower assembly 45 mated under the upper assembly 41. The upper assembly 41 includes a plurality of flexible domes 43 corresponding to the key portions 22. The lower assembly 45 includes a circuit board 47 with a plurality of exposed conductive tracks 49 thereon corresponding to the domes 43, thereby a plurality of switches are formed between the domes 43 and the conductive tracks 49.

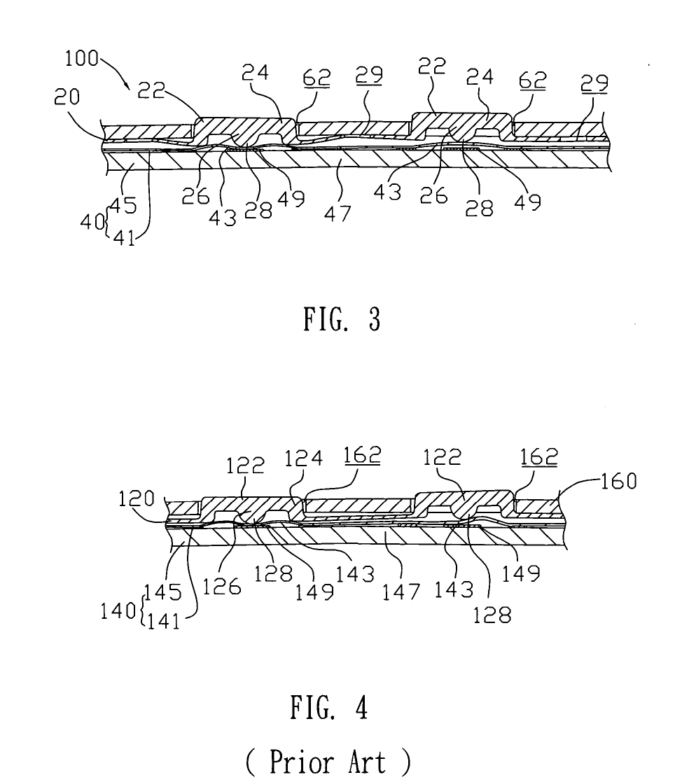

Please refer to FIG. 3 in greater detail. When the key portion 20 is pressed, the protuberance 28 urges the dome 43 to deform to the configuration illustrated in FIG. 3, in which the dome 43 bridges the conductive tracks 49 of the switch assembly 40 and connects them together electrically. When the key portion 22 is released, the dome 43 returns to its natural state as shown in FIG. 1, disconnecting the tracks 49 from each other. The advantage is that the slot 29 between the pair of the adjacent key portions 22 destroys the linkage there-between. So when one key portion is pressed down, the slot 29 prevents the pressure on the given key portion from being transferred to its adjacent key portions. Thus it is less probable to drag down the adjacent key portions, thereby unwanted key presses on the adjacent key portions are avoided.

In particular, alternative configurations for the slot 29 may be envisaged. For instance, rather than being rectangular, the slot 29 could also be a square slot, a triangular slot, a polygonal slot, an arc-shaped slot, a circular slot, or an irregular slot. The plurality of slots 29 disposed in the key-mat 20 could be selected from any type or a combination of the above-mentioned slots. These would still function as destroying the linkage between the adjacent key portions 22.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to a person skilled in the art are intended to be included within the scope of this invention as defined by the accompanying claims.

1. A keypad device comprising:
a key-mat having a plurality of spaced key portions and a plurality of slots, each of said slots being independently defined between two adjacent key portions so that the slots immediately neighboring a same key portion are separated; and
a switch assembly including a plurality of switches disposed under said respective key portions;
wherein linkage between said adjacent key portions is destroyed, whereby unwanted key presses on said adjacent key portions are avoided.

2. The keypad device as claimed in claim 1, wherein each of said slots is selected from a group comprising the following:
a rectangular slot,
a square slot,
a triangular slot,
a polygonal slot,
an arc-shaped slot,
a circular slot, and
an irregular slot.

3. A key-mat for use in a keypad device that includes a switch assembly having a plurality of switches comprising:
a plurality of spaced key portions disposed thereon and overlying said respective switches; and
a plurality of slots each being independently defined between two adjacent key portions so that the slots immediately neighboring a same key portion are separated and linkage between said adjacent key portions is destroyed.

4. The key-mat as claimed in claim 3, wherein each of said slots is selected from a group comprising the following:
a rectangular slot,
a square slot,
a triangular slot,
a polygonal slot,
an arc-shaped slot,
a circular slot, and
an irregular slot.
